(19) United States
(12) Patent Application Publication
(10) Pub. No.: US 2007/0010640 A1
(43) Pub. Date: Jan. 11, 2007

(54) Oligomerisation catalyst based upon an octanuclear nickel cluster

(76) Inventors: Abbas Razavi, Mons (BE); Olivier Lavastre, Gahard (FR); Caroline Hillairet, Casteau (BE)

Correspondence Address: David J Alexander;Fina Technology Inc, P O Box 674412, Houston, TX, 77267-4412, US

(21) Appl. No.: 10/547,953

(22) PCT Filed: Mar. 2, 2004
(86) PCT No.: PCT/EP04/02145

§ 371 Date: Aug. 24, 2006

(30) Foreign Application Priority Data
Mar. 7, 2003 (FR) 0302833

(51) Int. Cl. B01J 31/00; C08F 4/80; C08F 4/02

(52) U.S. Cl. 526/171; 526/348.5; 502/150; 502/162; 502/103

(57) ABSTRACT

The present invention discloses a catalyst component based upon a Nib cluster made of two sheets each containing four nickel atoms and that is the reaction product of: a) a first component of the general formula (I) b) a second component based on complex, of the general formula (II) wherein in the first component, the benzene ring can be substituted in positions 3 and/or position and/or position 5 and/or position 6, wherein R and R′ are the same or different and can be selected from a phenyl, substituted or unsubstituted or a cycloalkyl or an alkyl having from 1 to 20 carbon atoms, wherein Q is a cation, and wherein, in the second component, R″ is selected from a halogen or an acetate and wherein the two arrows mean that there are two vacant sites. It also discloses a catalyst system and a process for the oligomerisation of olefins.

This invention discloses a catalyst system based on nickel that is very active for the oligomerisation of olefins.

Nickel in molecular complex form has been used to prepare catalyst system useful in the oligomerisation or polymerisation of olefins.

For example, Komon et al. (Z. J. A. Komon, X. Bu and G. C. Bazan, in J. Am. Chem. Soc., 2000, 12379.) have disclosed the preparation of branched polyethylene involving molecular complexes of nickel and phosphino-carboxylate ligands.

Bonnet et al. (M. C. Bonnet, F. Dahan, A. Ecke, W. Keim, R. P. Schulz and I. Tkatchenko, in J. Chem. Soc. Chem. Comm., 1994, 615.) discloses the synthesis of new neutral and cationic methallyl nickel complexes containing chelating ligand suitable for the oligomerisation of ethylene.

More generally, the preparation of nickel-based complexes is discussed in several prior art documents.

Rieck et al. (D. F. Rieck, A. D. Rae and L. F. Dahl, in Chem. Comm., 1993, 585.) discloses the synthesis and structural-bonding analysis of [Ni₈(PCMe₃)₂(PMe)₂(CO)₁₂].

Lower and Dahl (L. D. Lower and L. F. Dahl, in J. AM. Chem. Soc., 1976, 5046.) discloses the synthesis and structural characterisation of the new metal cluster system Ni₈(CO)₈(μ₄—PC₆H₅)₆ that exhibits a completely bonding metal cube as a basic structural unit.

Winpenny (R. E. P. Winpenny, in J. Chem. Soc. Dalton Trans., 2002, 1.) discloses polynuclear compounds including nickel and cobalt cages. Cages of up to 24 metal centres are presented.

All these work are fragmentary and there is thus a need for improving the efficiency and activity of the nickel-based oligomerisation catalyst systems.

The present invention discloses a catalyst system based on a Ni8 cluster that is very active in the oligomerisation of several alpha-olefins.

The present invention further discloses the use of the catalyst system based on a Ni8 cluster to prepare in situ the comonomers necessary for the copolymerisation of alpha-olefins.

Accordingly, the present invention discloses a catalyst component based upon a Ni8 cluster made of two sheets each containing four nickel atoms and that is the reaction product of:
a) a first component of the general formula 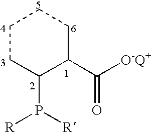
b) a second component based on a complex with a ligand in which L is independent or chelating L₂ and which could be easily displaced (ex: ethylene glycol dimethyl ether), of the general formula 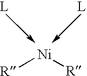
   wherein in the first component, the benzene ring can be substituted in positions 3 and/or position 4 and/or position 5 and/or position 6, wherein R and R′ are the same or different and can be selected from a substituted or unsubstituted phenyl, or a substituted or unsubstituted cycloalkyl or a substituted or unsubstituted alkyl having from 1 to 20 carbon atoms, wherein Q is a cation, and wherein, in the second component, R″ is selected from a halogen or an acetate and wherein the two arrows mean that there are two vacant sites.

The substituents on the benzene ring can have either an inductive attracting or donating effect.

The substituents that have an inductive attracting or donating effect can be selected from hydrogen or an alkoxy, or NO₂, or CN, or CO₂R or an alkyl having from 1 to 20 carbon atoms, or a halogen or CX₃ wherein X is a halogen, preferably fluor, or a fused ring between positions 3 and 4, or between positions 4 and 5 or between positions 5 and 6.

R and R′ are preferably the same and more preferably unsubstituted or substituted phenyls. The substituents on the phenyls, if present, can be selected from the same list as that disclosed here-above for the benzene ring.

The steric effect of the Ni8 cluster is determined by the substituents at positions 3 and 6 on the benzene ring and by the substituents at positions 2 and 6 and optionally at positions 3 and 5 on the phenyls.

For the steric effect, the preferred substituents on the benzene ring and on the phenyls, if present, can be selected from tert-butyl, propyl or methyl. The most preferred substituent is tert-butyl.

An olefinic system —CR═CR— between C1 and C2, may be used instead of the benzene ring

R″ is preferably selected from CI, Br, I or CH₃CO₂—. More preferably, it is Br. R″ remains in the final Ni8 cluster and insures the interaction between the two sheets, each containing the 4 nickel atoms, constituting the Ni8 complex. Its nature thus has an influence on the final structure of the Ni8 cluster and therefore on its activity as an oligomerisation catalyst.

The present invention also discloses a process for preparing a catalyst component based upon a Ni8 cluster made of two sheets each containing 4 nickel atoms, that comprises the steps of:
a) providing a first component of the general formula 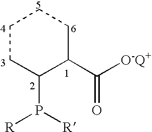
b) providing a second component based on a complex of the general formula 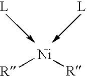
c) adding a solvent,
d) stirring for from 4 to 20 hours,
e) retrieving a powder of the Ni8 cluster.

The solvent is preferably dichloromethane.

The present invention also discloses a catalyst system based upon the Ni8 cluster and an activating agent.

The present invention further discloses a process for oligomerising alpha-olefins that comprises the steps of:
a) injecting a catalyst system based upon the Ni8 cluster and an activating agent in the reactor,
b) injecting an optional co-catalyst,
c) feeding the monomer in the reactor,
d) maintaining under oligomerisation conditions,
e) retrieving the oligomers.

The activating agent can be selected from alumoxanes or aluminium alkyls or boron-based activating agents.

The aluminium alkyls are of the formula AlR_{X} and can be used wherein each R is the same or different and is selected from halides or from alkoxy or alkyl groups having from 1 to 12 carbon atoms and x is from 1 to 3. Especially suitable aluminiumalkyl are dialkylaluminum chloride, the most preferred being diethylaluminum chloride (Et₂AlCl).

Alumoxane is used to activate the catalyst component during the oligomerisation procedure, and any alumoxane known in the art is suitable.

The preferred alumoxanes comprise oligomeric linear and/or cyclic alkyl alumoxanes represented by the formula: 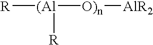
for oligomeric, linear alumoxanes
and 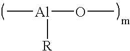
for oligomeric, cyclic alumoxanes,

wherein n is 1-40, preferably 10-20, m is 3-40, preferably 3-20 and R is a C₁-C₈ alkyl group and preferably methyl. Methylalumoxane (MAO) is preferably used.

Suitable boron-based activating agents may comprise triphenylcarbenium boronate such as tetrakis-pentafluorophenyl-borato-triphenylcarbenium [C (Ph)₃⁺ B(C₆F₅)₄⁻] as described in EP-A-0,427,696

Other suitable boron-containing activating agents are described in EP-A-0,277,004.

The conditions of temperature and pressure for the oligomerisation reaction are not particularly limited.

The oligomerisation temperature can range from −25 up to 120° C., preferably from 0 to 50° C. and most preferably around room temperature (about 20° C.). When the temperature increases, the catalyst system tends to deactivate.

The pressure in the reactor can vary from 0.5 to 50 bars, preferably from 1 to 20 bars and most preferably, from 5 to 10 bars.

The oligomers obtained with the catalyst system of the present invention were characterised by gas phase chromatography and/or by nuclear magnetic resonance (NMR).

The present invention yet discloses the use, in the copolymerisation of olefins, of the catalyst system to prepare comonomer(s) in situ.

### LIST OF FIGURES

FIG. 1 represents the gas phase chromatography for the oligomers of ethylene.

FIG. 2 represents the gas phase chromatography for the oligomers of propylene.

FIG. 3 represents the gas phase chromatography for the oligomers of hexene.

FIG. 4 represents the ¹H NMR spectrum of oligomers of 1-hexene.

### EXAMPLES

All reactions were carried out on a vacuum line under argon using standard glovebox and Schlenk techniques.

Synthesis of Sodium 2-(diphenylphosphino)-benzoate.

306 mg (1 mmol) of 2-(diphenylphosphino)-benzoic acid were dissolved in 5 mL of dry tetrahydrofuran (THF). The solution was cooled at −5° C. and a suspension of 24 mg (1 mmol) of sodium hydride in 5 mL of THF was added dropwise. The mixture was allowed to stir for 3 hours at 0° C. After decantation, the white solid so obtained was filtered off and washed twice with 5 mL of THF and with 5 mL of pentane to yield 295 mg (0.89 mmol; 90%) of the white solid. The ³¹P NMR spectra, recorded on a Bruckner DPX 200 at 81 MHz gave a shift, for ³¹P{¹H}(81 MHz, solvent DMSO-d6,δ)=−7.5.

Synthesis of Sodium 2-diphenylphosphino-5-methyl-benzoate or of Sodium 2-diphenylphosphino-6- methoxy-benzoate.

Step 1. Preparation of potassium 5-methyl-2-fluorobenzoate or of potassium 6-methoxy-2-fluorobenzoate

In a Schlenk, under argon, 3 mmoles of 5-methyl-2-fluorobenzoate acid or of 6-methoxy-2-fluorobenzoic acid, were dissolved in 3 ml of degased tetrahydrofuran (THF) and the system was cooled to a temperature of −15° C. In another Schlenk containing 3.3 mmoles potassium hydride (KH), 4 mL of THF were added. The acid solution was syringed on the KH suspension and the Schlenk was rinsed twice with 4 mL of THF. The cool bath was retrieved and the mixture was stirred at room temperature (about 25° C.) for a period of time of 3 hours. After decantation, the THF was filtered and the solid was rinsed with 5 mL of pentane and then dried under vacuum. The yield for both products was of 92%, they were characterised by ¹H NMR.
potassium 5-methyl-2-fluorobenzoate: ¹H NMR (300 MHz, acetone D₆) δ (ppm): 6.82, 6.85, 7.26 (3H, H_{AR}); 2.22 (3H, s, CH₃).
potassium 6-methoxy-2-fluorobenzoate: ¹H NMR (200 MHz, DMSO) δ (ppm): 6.54-7.05 (3H, H_{Ar}); 3.69 (3H, s, CH₃).

Step 2. Preparation of 2-diphenylphosphino-5-methyl-benzoic acid or of 2-diphenylphosphino-6-methoxy-benzoic acid.

In a Schlenk under argon containing 3 mmoles of either of the products obtained in step 1, 10 mL of degased THF were added and the system was cooled to a temperature of −78° C. 3 mmoles of KPPh₂ were added drop-wise and the mixture was stirred at room temperature for a period of time of from 2 to 12 hours and then under reflux for a period of time of from 12 to 24 hours. The THF was vaporised and 15 mL of ether were added. The organic phase was washed with 15 mL of degased distilled water. The liquid phase was washed twice with 10 mL of ether, filtered and then acidified with a 0.5 M hydrochloric acid to a pH of from 3 to 4. The white precipitate was filtered and dried under vacuum for one night.

2-diphenylphosphino-5-methyl-benzoic acid was obtained with a yield of 82% and had the following characteristics:
¹H NMR (200 MHz, DMSO) δ (ppm): 8.03 (3H, m, H_{Ar}); 7.36 (11H, m, H_{Ar}); 6.90 (1H, m, H_{Ar}); 2.44 (3H, s, CH₃).
³¹P NMR (200 MHz, DMSO) δ (ppm): −8.91.

2-diphenylphosphino-6-methoxy-benzoic had the following characteristics:
³¹P NMR (200 MHz, DMSO) δ (ppm): −6.79; −11.17.

Step 3. Preparation of sodium 2-diphenylphosphino-5-methyl-benzoate or of sodium 2-diphenylphosphino-6methoxy-benzoate.

In a Schlenk, under argon containing 0.3 mmoles of either of the products obtained in step 2, 5 mL of just distilled and degased THF were added and the solution was cooled down to a temperature of −10° C. 0.3 mmoles of sodium hydride were added in one shot and the mixture was stirred at room temperature for a period of time of 3 hours. The THF was vaporised under vacuum and the residue was washed twice with 5 mL of distilled pentane. The white solid residue was dried under vacuum.

Sodium 2-diphenylphosphino-5-methyl-benzoate was obtained with a yield of over 99% and had the following characteristics:
¹H NMR (200 MHz, DMSO) δ (ppm): 7.80-6.60 (13H, m, H_{Ar}); 1.55 (3H, s, CH₃).
³¹P NMR (200 MHz, DMSO) δ (ppm): −6.52.

Sodium 2-diphenylphosphino-6-methox-benzoate was a mixture of products and had the following characteristics:
³¹P NMR (200 MHz, DMSO) δ (ppm): −4.59; −11.25.
   Synthesis of Ni₈ Cluster.

100 mg (0.3 mmol) of sodium 2-(diphenylphosphino)-benzoate and 124 mg (0.4 mmol) of dibromo 1,2-(dimethoxy-ethylene glycol dimethylether) nickel ((DME)NiBr₂) were introduced in a Schlenk tube. 15 mL of dichloromethane were added and the suspension was stirred overnight. The brown solution turned to green and was filtered off over celite. The solution was concentrated under vacuum to approximately 2 mL and 20 mL of pentane were added to obtain the Ni₈ cluster 1 as a pale green powder (142 mg; 0.049 mmol; 97%).

The exact same procedures were repeated with 0.3 mmoles of sodium 2-diphenylphosphino-5-methyl-benzoate to obtain the Ni₈ cluster 2 as a dark green powder and with 0.3 mmoles of sodium 2-diphenylphosphino-6-methoxy-benzoate to obtain the Ni₈ cluster 3 as a pale green powder.

High resolution mass spectra were obtained on a ZabSpec TOF Micromass at CRMPO (Rennes University). The results were as follows: (Fast Atom Bombardment (FAB), solvent: mNBA): m/z=2830.3469 (M)⁺. The calculations for C₁₁₃H₈₄O₁₁ ⁷⁹Br ⁸¹Br₆P₆ ⁵⁸N₈ gave a value of 2830.3428.

Single crystals of the Ni8 cluster 1, suitable for a single crystal X-ray determination were obtained by vapor diffusion of pentane into 1,2-dichloroethane solution. The unit cell constant, space group determination and the data collection were carried out on an automatic NONIUS Kappa CCD diffractometer with graphite monochromatised Mo-Kα radiation. The cell parametres were obtained with Denzo and Scalepack with 10 frames (psi rotation: 10 per frame). The structure was solved with SIR-97 that reveals the non-hydrogen atoms of the structure. After anisotropic refinement, many hydrogen atoms may be found with a Fourier Difference. The whole structure was refined with SHELXL97 by full-matrix least-square techniques (use of F square magnitude; x, y, z, βij, for Ni, Br, P, O and C atoms, and x, y, z in riding mode for H atoms). It must be noted that some residual peaks are present that are probably cause by DME. The atomic scattering factors are obtained from The International Tables for X-ray Crystallography.

High Pressure Oligomerisation of Ethylene.

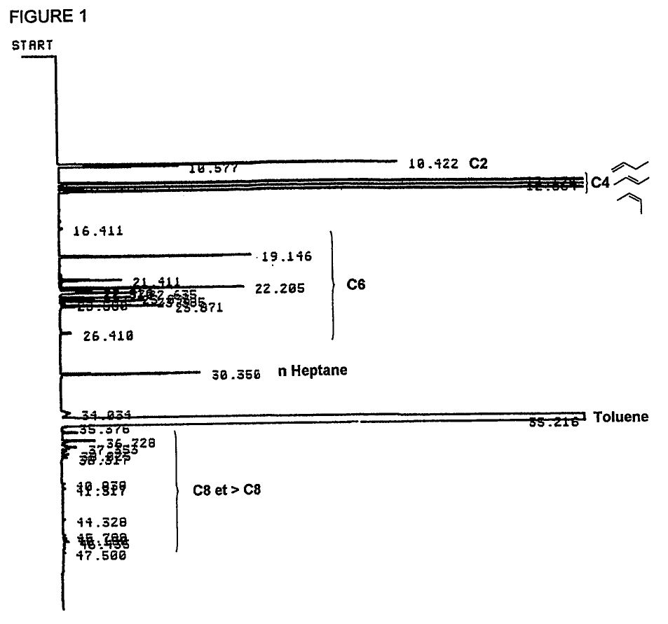

The oligomerisation has been carried out in a 190 mL stainless steel computer-controlled autoclave, equipped with mechanical stirring, thermocouple and pressure gauge. For a typical reaction run, 55 mL of dry toluene were introduced in the reactor. In a nitrogen-filled glovebox, 3.75 mg (1.3 μmol) of Ni₈ cluster 1 were weighted, activated with a) 2.35 mL of MAO (30 wt % Al, [Al]:[Ni]=2000) or with b) 3.5 mL of Et₂AlCl (25 wt % Al, [Al]:[Ni]=1000) and diluted with toluene to a final volume of 25 mL. 5 mL of the solution of activated catalyst were placed inside the reactor. The ethylene pressure was raised to the desired value and continuously fed into the reactor. After one hour, the reaction was stopped and the solution was analysed by gas phase chromatography performed on a HP 5890 Series II apparatus with a DB-Petro capillary column (methyl silicone, 100 m long, internal diameter of 0.25 mm and film thickness of 0.5 μm), working at 35° C. for 15 minutes and then heating at the rate of 5° C. per minute to a final temperature of 250° C. Oligomerisation results for several conditions of temperature and pressure are displayed in Table I and FIG. 1.

Oligomerisation of Ethylene at Atmospheric Pressure.

5 mL of the solution of activated catalyst described here-above were placed in a Schlenk tube containing 55 mL of toluene cooled at −15° C. The Schlenk tube was purged with ethylene and the content was magnetically stirred and maintained under ethylene throughout the run. After 3 hours, 6 mL (5 g) of oligomers were obtained: they were analysed by gas phase chromatography. The oligomerisation results are also displayed in Table I.

TABLE I

| | Temper- | Acti- | Activity | | | | |
|---|---|---|---|---|---|---|---|
| Pressure | ature | vating | T C2/mol | C4 | Butène-1 | C6 | C8+ |
| bar | ° C. | agent | cat/h | % | % | % | % |
| 7 | 20 | Et₂AlCl | 21.0 | 94 | 86 | 5.2 | 0.8 |
| 7 | 20 | MAO | 49.8 | 67 | 33 | 30 | 3 |
| 7 | 50 | MAO | 15.9 | 67 | 50 | 28.5 | 4.5 |
| 20 | 50 | MAO | 13.2 | 68 | 66 | 30 | 2 |
| 40 | 100 | MAO | 12.0 | 79 | 64 | 17 | 4 |
| 1 | −15 | MAO | 19.4 | 68 | 24 | 27 | 5 |

A higher selectivity for C4 is obtained with Et₂AlCl compared to MAO.

The oligomerisation of ethylene was repeated with Ni₈ clusters 2 and 3 as described in Table II

TABLE II

| Ni₈ | | | Acti- | Activity | | | | |
|---|---|---|---|---|---|---|---|---|
| clus- | Press. | Temp. | vating | T C2/mol | C4 | Butène-1 | C6 | C8+ |
| ter | bars | ° C. | agent | cat/h | % | % | % | % |
| 1 | 7 | 20 | MAO | 49.8 | 67 | 33 | 30 | 3 |
| 2 | 7 | 20 | MAO | 51.9 | 63 | 20 | 30 | 7 |
| 3 a | 7 | 20 | MAO | 4.3 | 74 | 72 | 15 | 11 |

a The ligand was obtained with a purity of about 45%.
Oligomerisation of Propylene.

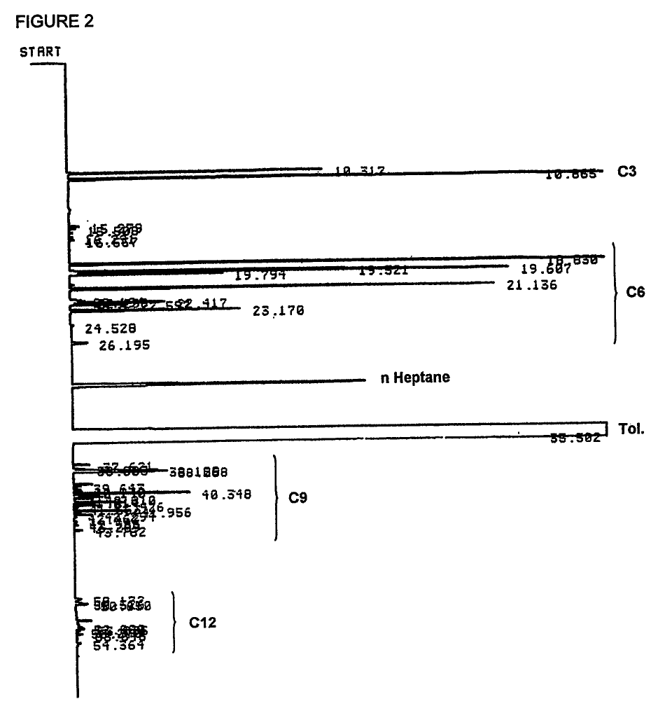

5 mL of the solution of activated catalyst (from 1) described here-above were placed inside the reactor. The propylene pressure was raised to the desired value and continuously fed into the reactor. After one hour, the reaction was stopped and the solution was analysed by gas phase chromatography using the same procedure and equipment as those described for ethylene. The oligomerisation was carried out at a pressure of 3 bars and a temperature of 20° C. The activity was measured as the quantity of propylene consumed per mole of catalyst and per hour. It was of 19.4 tons propylene/mol cata/h and starting the reaction with 0.26 μmol (0.75 mg) of catalyst: 4 mL (3.6 g) of oligomers were obtained after one hour. The distribution of oligomers was: 77% of C6, 21% of C9 and 2% of C12 and higher as seen in FIG. 2.

Oligomerisation of 1-hexene.

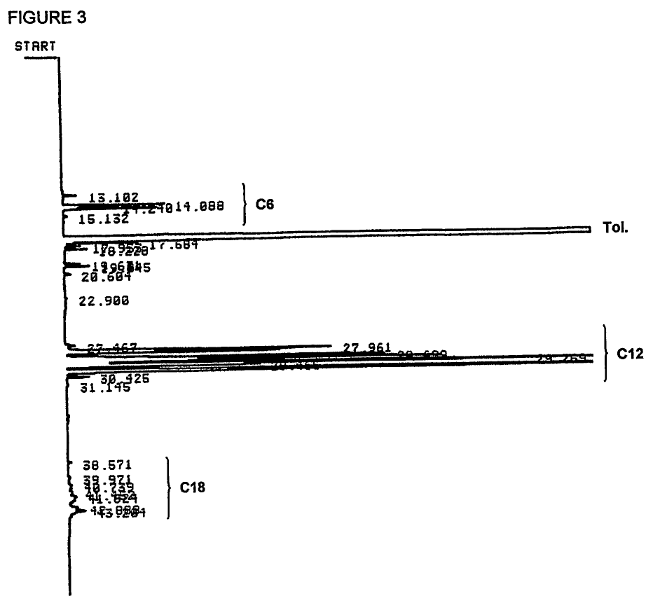

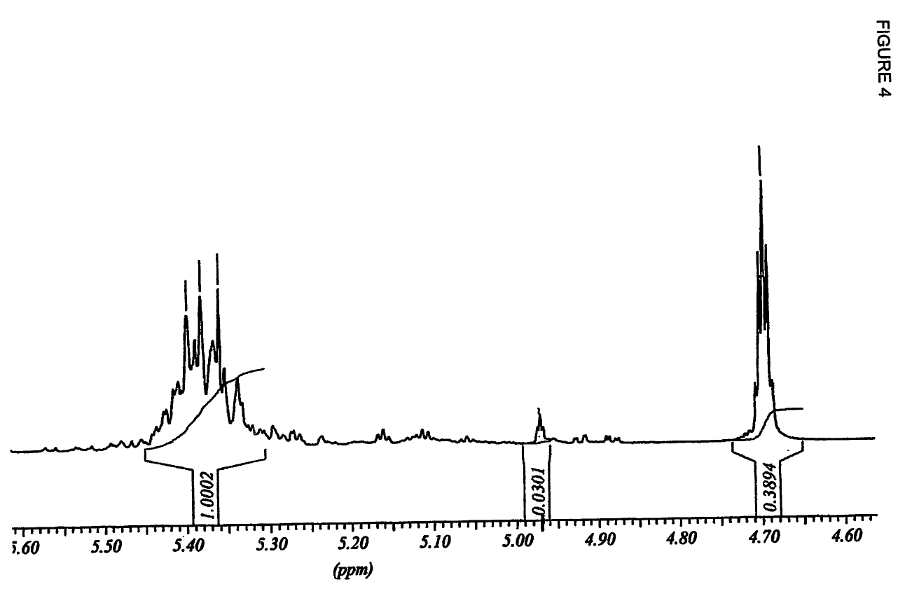

In a nitrogen-filled glove box, 3.5 mg ( 1.2 μmol) of the Ni8 cluster 1 were activated with 2.2 mL of MAO (30 wt % Al, [Ni]:[Al]=2000) and diluted with toluene to a final volume of 12 mL. 5 mL of the solution of activated catalyst were placed in a Schlenk tube containing 25 mL of toluene and 30 mL of 1-hexene. The solution was stirred at 30° C. for 5 hours. The mixture was quenched with methanol and slightly acidified water. The aqueous layer was removed and the solvents evaporated to yield 1.1 g of oligomers and the activity was thus measured as 400 kg of oligomers/mol cata/hour. The oligomers were analysed by NMR and by gas phase chromatography that was performed on the same apparatus as that used for ethylene and propylene, but working at 100° C. for 4 minutes and then heating at a rate of 8° C. per minute to a final temperature of 250° C. The distribution of oligomers is of 95% of C12 and 5% of C18. The NMR analysis shows that 72% of the olefins are linear and 28% have one ═CH₂ branch. The gas phase chromatography results are displayed in FIG. 3 and the NMR results can be seen in FIG. 4.

1-12. (canceled)

13. A catalyst component comprising a Ni8 cluster made of two sheets, with each sheet containing four nickel carbon atoms that is the reaction product of:
(a) a first component of the general formula: 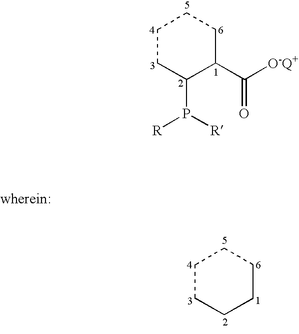
is a substituted or unsubstituted benzene ring or an olefinic group having carbon atoms at the 6, 1, 2, and 3 positions and a double bond between the carbon atoms at the 1 and 2 positions;
R and R¹ are the same or different and are a substituted or unsubstituted phenyl group or a substituted or unsubstituted cycloalkyl group or an alkyl group having from 1 to 20 carbon atoms;
and Q is a cation;
(b) a second component of the general formula: 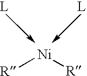
wherein:
each L is a displaceable ligand; and
R″ is a halogen or an acetate group.

14. The catalyst component of claim 13 wherein Q is Na.

15. The catalyst component of claim 13 wherein R and R′ are phenyl groups.

16. The catalyst component of claim 13 wherein: 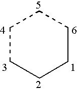
is a substituted or unsubstituted benzene ring.

17. The catalyst component of claim 16 wherein said benzene ring is substituted at at least one of the 3 and 6 positions.

18. The catalyst component of claim 17 wherein said benzene ring is disubstituted at the 3 and 6 positions.

19. The catalyst component of claim 17 wherein said benzene ring is substituted with a tertiary butyl group, a propyl group, or a methyl group.

20. The catalyst component of claim 19 wherein said benzene ring is substituted with a tertiary butyl group.

21. The catalyst component of claim 20 wherein said benzene ring is disubstituted at the 3 and 6 positions with tertiary butyl groups.

22. The catalyst component of claim 18 wherein R and R′ are phenyl groups.

23. The catalyst component of claim 22 wherein each of said phenyl groups is disubstituted at the 2 and 6 positions.

24. The catalyst component of claim 23 wherein the substituents on said phenyl groups are selected from the group consisting of tertiary butyl, propyl and methyl groups.

25. The catalyst component of claim 24 wherein the substituents on said phenyl groups are tertiary butyl groups.

26. A catalyst system comprising the catalyst component of claim 13 and an activating agent selected from the group consisting of an alumoxane activating agent, an aluminum alkyl activating agent, or a boron-based activating agent.

27. The catalyst system of claim 26 wherein said activating agent is selected from the group consisting of methyl alumoxane and diethylaluminum chloride.

28. A process for producing an olefin ligomer comprising:
(a) introducing the catalyst system of claim 26 into a reactor;
(b) introducing an olefin monomer into said reactor and into contact with said catalyst system;
(c) maintaining said reactor containing said catalyst system and monomer under conditions effective for the ligomerization of said monomer; and
(d) recovering an oligomer of said monomer from said reactor.

29. The method of claim 28 wherein said monomer is selected from the group consisting of ethylene, propylene or 1-hexene.

30. A method for preparing the catalyst component of claim 13 comprising:
(a) providing a first component of the general formula: 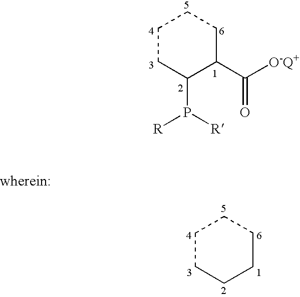
is a substituted or unsubstituted benzene ring or an olefinic group having carbon atoms at the 6, 1, 2, and 3 positions and a double bond between the carbon atoms at the 1 and 2 positions;
R and R′ are the same or different and are a substituted or unsubstituted phenyl group or a substituted or unsubstituted cycloalkyl group or an alkyl group having from 1 to 20 carbon atoms;
and Q is a cation;
(b) providing a second component of the general formula: 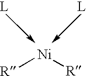
wherein:
each L is a displaceable ligand; and
R″ is a halogen or an acetate group;
(c) adding said first component and said second component to a polar solvent;
(d) stirring the mixture of said first and second components and said polar solvent for a time period within the range of 4-20 hours; and
(e) retrieving a Ni8 cluster formed as a reaction product of said first and second components.

31. The method of claim 30 wherein: 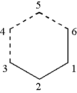
is a substituted or unsubstituted benzene ring.

32. The method of claim 31 wherein said benzene ring is disubstituted at the 3 and 6 positions.
